(19) United States
(12) Patent Application Publication
(10) Pub. No.: US 2017/0029091 A1
(43) Pub. Date: Feb. 2, 2017

(54) PROPELLER HAVING EXTENDING OUTER BLADE

(71) Applicants: JONATHON J. LINCH, LOS ANGELES, CA (US); KYLE M. RAHRIG, REDONDO BEACH, CA (US)

(72) Inventors: JONATHON J. LINCH, LOS ANGELES, CA (US); KYLE M. RAHRIG, REDONDO BEACH, CA (US)

(73) Assignee: NORTHROP GRUMMAN SYSTEMS CORPORATION, FALLS CHURCH, VA (US)

(21) Appl. No.: 14/810,109

(22) Filed: Jul. 27, 2015

(51) Int. Cl. B64C 11/00; B64C 39/02

(52) U.S. Cl. CPC B64C 11/001; B64C 39/024; B64C 2201/024; B64C 2201/108

(57) ABSTRACT

A propeller includes a hub coaxially surrounding a longitudinal axis. A ring shroud coaxially surrounds the longitudinal axis and is spaced radially from the hub. The ring shroud includes an inner ring surface and a radially spaced, oppositely facing outer ring surface. At least one propeller blade is fixedly attached to both the hub and the inner ring surface and extends radially therebetween for mutual rotation therewith. At least one extending blade has a first extending blade end radially spaced from a second extending blade end. The first extending blade end is fixedly attached to the outer ring surface. The second extending blade end is cantilevered from the first extending blade end and is radially spaced from the ring shroud.

### TECHNICAL FIELD

This disclosure relates to an apparatus and method for use of a propeller and, more particularly, to a ring propeller having extending outer blades for achieving desired noise reduction and cancellation effects.

### BACKGROUND

Many manned and unmanned air vehicles (“UAVs”) are driven by propellers and rely on quiet acoustic signatures to enhance mission effectiveness. Given the nature of typical missions and operations, it may be desirable to reduce aural detectability. The ability to cancel or substantially reduce critical tones of a propeller system's acoustic signature may be important to certain concepts of operation. Small UAVs typically use fixed-pitch propellers that are neither subject to the complexities nor the stresses of variable pitch propellers which are typically used for manned vehicles or large UAVs. Hence, innovative propeller concepts that are subject to structural constraints may be better implemented on these less -complex systems, compared to manned vehicles or large UAVs.

### SUMMARY

In an embodiment, a propeller is described. A hub coaxially surrounds a longitudinal axis. A ring shroud coaxially surrounds the longitudinal axis and is spaced radially from the hub. The ring shroud includes an inner ring surface and a radially spaced, oppositely facing outer ring surface. At least one propeller blade is fixedly attached to both the hub and the inner ring surface and extends radially therebetween for mutual rotation therewith. At least one extending blade has a first extending blade end radially spaced from a second extending blade end. The first extending blade end is fixedly attached to the outer ring surface. The second extending blade end is cantilevered from the first extending blade end and is radially spaced from the ring shroud.

In an embodiment, a propeller is described. A hub coaxially surrounds a longitudinal axis. A ring shroud coaxially surrounds the longitudinal axis and is spaced radially from the hub. The ring shroud includes an inner ring surface and a radially spaced, oppositely facing outer ring surface. A plurality of motive blades extends radially with respect to the longitudinal axis. Each motive blade has a blade root directly attached to a chosen one of the hub and the outer ring surface, for rotation about the longitudinal axis due to the attachment to the chosen one of the hub and the outer ring surface, and a blade tip extending radially away from the longitudinal axis. At least one selected blade tip is directly attached to the inner ring surface. At least one other blade tip is cantilevered from the outer ring surface and is radially spaced apart from the outer ring surface.

In an embodiment, an aircraft is described. The aircraft includes a body, at least one fixed wing and at least one propeller mount extending from the body, and at least one drive shaft positioned within a corresponding at least one propeller mount and drivable by a motor or gear/clutch system. At least one propeller is operationally attached to the at least one drive shaft to obtain motive power therefrom. The propeller includes a hub coaxially surrounding a longitudinal axis. A ring shroud coaxially surrounds the longitudinal axis and is spaced radially from the hub. The ring shroud includes an inner ring surface and a radially spaced, oppositely facing outer ring surface. A plurality of motive blades extends radially with respect to the longitudinal axis. Each motive blade has a blade root directly attached to a chosen one of the hub and the outer ring surface, for rotation about the longitudinal axis due to the attachment to the chosen one of the hub and the outer ring surface, and a blade tip extending radially away from the longitudinal axis. At least one selected blade tip is directly attached to the inner ring surface. At least one other blade tip is cantilevered from the outer ring surface and is radially spaced apart from the outer ring surface.

### BRIEF DESCRIPTION OF THE DRAWINGS

For a better understanding, reference may be made to the accompanying drawings, in which:

FIG. 1 is a schematic perspective front view of one embodiment; and

FIG. 2 depicts the embodiment of FIG. 1 in an example use environment.

### DESCRIPTION OF ASPECTS OF THE DISCLOSURE

The invention comprises, consists of, or consists essentially of the following features, in any combination.

The Figures depict an example of a ring propeller for delaying the onset of aural detection by a human observer. This ring propeller may help provide improved aircraft performance by way of reduced operational altitude, yielding both aerodynamic and operational benefit. Propulsion mechanisms are generally the primary offending source mechanism for all modern day aircraft, with the exception of some ultralights and alternative energy designs. Other contributing sources include, but are not limited to, airframe, exhaust, and fan noise. Propellers present significant acoustic challenges in developing propulsion noise reduction technologies for attenuating volume dependent thickness and loading noise.

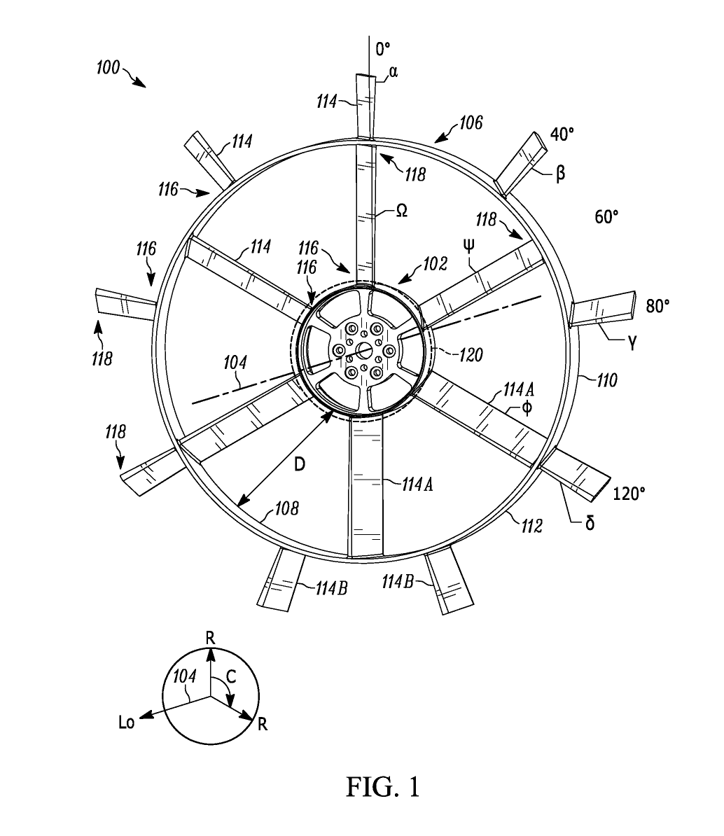

FIG. 1 depicts an example propeller 100 including a hub 102 coaxially surrounding a longitudinal axis 104. The term “coaxial” is used herein to indicate that the objects described as such have coincident axes (here, both the hub 102 and the propeller 100 share the longitudinal axis 104). The hub 102 here is shown as having a central “sunburst” type structure (including lightening holes) for attachment to a particular type of propeller shaft (not shown), but may be of any suitable type and can readily be configured for a particular use environment by one of ordinary skill in the art.

A ring shroud 106 coaxially surrounds the longitudinal axis 104 and is spaced radially from the hub 102. A “radial” direction, as used here, is a direction in a plane substantially perpendicular to the longitudinal axis 104, such as, but not limited to, the example directions “R” shown by arrows in the coordinate system included in FIG. 1. The ring shroud 106 may include an inner ring surface 108 and an oppositely facing outer ring surface 110, which may be at least partially radially spaced from the inner ring surface 108 by a ring body 112. The ring shroud 106 is shown here as a substantially cylindrical “hoop” style ring including a substantially circular strip with a substantially thin rectangular cross-sectional shape. However, it is contemplated that one of ordinary skill in the art could provide a suitable ring shroud 106 for a particular use environment.

A plurality of motive blades 114, of any mix of types as will be described below, each extend radially with respect to the longitudinal axis 104. Each motive blade 114 has a blade root 116 attached (e.g., directly attached) to a chosen one of the hub 102 and the ring shroud 106 (such as to the outer ring surface 110), for rotation of that motive blade 114 about the longitudinal axis 104 due to such attachment. Each motive blade 114 also has a blade tip 118 extending radially away from the longitudinal axis 104. A blade “tip”, as used herein, may be cantilevered (free-hanging) or attached to any other structure.

As can be seen in FIG. 1, one or more of the plurality of motive blades 114 are of a type referenced herein as propeller blades 114A, having both the blade root 116 and the blade tip 118 for that propeller blade 114A directly attached to respective ones of the hub 102 and the ring shroud 106, with the body of the propeller blade spanning the distance D between the hub 102 and the inner ring surface 108. For example, the blade tips 118 of the propeller blades 114A may be directly attached to the inner ring surface 108. (It should be noted that the identification of a particular end of a motive blade 114 as a blade root 116 or blade tip 118 is done herein for orientation purposes only, and no indication or significance of a particular structural feature is implied or intended by this orienting terminology.)

One or more others of the plurality of motive blades 114 are of a type referenced herein as extending blades 114B, having the blade root 116 directly attached to the ring shroud 106. In contrast to the propeller blades 114A, however, these extending blades 114B each have a blade tip 118 that is cantilevered from the blade root 116 and is radially spaced apart from the outer ring surface 110, radially beyond the ring shroud 106. The term “cantilevered” is used herein to indicate a projecting beam or other horizontal member supported at one or more points (e.g., the blade root 116) but not at both ends. For example, the extending blades 114B may each be directly attached to the outer ring surface 110 but have a blade tip 118 that extends, in a cantilevered relationship, away from the outer ring surface 110 and is radially spaced therefrom.

It is noted that the extending blades 114B will generally be smaller, in at least one dimension, than the propeller blades 114A. This may be, for example, due to structural and/or motive forces associated with each of these types of motive blades 114, and/or the ability of the ring shroud 106 to help stabilize the propeller blades 114A. However, any combination of geometry, thrust contribution, or any other factors may be considered in providing a plurality of motive blades 114 for a desired propeller 100. Though the Figures are not drawn to scale, the extending blades 114B are shown, e.g., as being shorter in the radial direction, as well as narrower, than the propeller blades 114A. The extending blades 114B could be the same length as, or longer than, the propeller blades 114A. It is also contemplated that any combination of propeller blades 114A and extending blades 114B, having any suitable lengths (which need not be the same for all blades of a particular type), could be provided.

The propeller blades 114A are fixedly attached to both the hub 102 (e.g., via direct attachment of the blade roots 116 to the hub 102) and the ring shroud 106 (e.g., via direct attachment of the blade tips 118 to the inner ring surface 108) and extend radially therebetween for mutual rotation therewith. That is, the hub 102, propeller blades 114A (six shown in FIG. 1), and ring shroud 106 are attached together and rotate about the longitudinal axis 104 as a unit, under motive force. Generally, the motive force will be provided to the hub 102 via a drive shaft (not shown) extending along the longitudinal axis 104, but it is contemplated that other drive means, of any desired type, may exert motive force upon any structure (e.g., the ring shroud 106) of the described propeller 100.

The extending blades 114B are fixedly attached to the ring shroud 106 (e.g., via direct attachment of the blade roots 118 to the outer ring surface 110) and extend radially away from the ring shroud 106 for mutual rotation therewith. That is, the extending blades 114B (nine shown in FIG. 1), and ring shroud 106 are attached together and rotate about the longitudinal axis 104 as a unit, under motive force. Generally, the motive force will be provided to the hub 102 via a drive shaft (not shown) extending along the longitudinal axis 104 and transmitted to the ring shroud 106 by one or more propeller blades 114A, but it is contemplated that other drive means, of any desired type, may exert motive force upon any structure (e.g., the ring shroud 106) of the described propeller 100.

As is known to one of ordinary skill in the propeller arts, one or more of the motive blades 114 may be angled in a selected “twist direction”, as can be seen in the perspective view of FIG. 1. The cross-sectional shape of the motive blade 114 changes over the length of the motive blade 114, resulting in a twist, as shown. Optionally, the blade root 116 and/or blade tip 118 of a single blade 114 may be attached to a respective hub 102 or ring shroud 106 at an angle to aid with creating, maintaining, and/or carrying out a particular twist configuration. The twist helps the propeller 100 produce a desired thrust profile, and a twist design considers factors including lift, relative speed of the motive blade 114 at various points along its radial length (e.g., along distance R), angle of attack, the weight of the aircraft, the speed of the propeller 100 (RPM), the power provided through the drive shaft, and the final thrust required to maintain flight.

Optionally, selected motive blades 114 of the propeller 100 could be angled in the same or different twist directions from other motive blades 114 of the same propeller. For example, some or all of the propeller blades 114A could be angled in a first twist direction, while some or all of the extending blades 114B could be angled in a second twist direction which is substantially opposite the first twist direction. As another example, one or more propeller blades 114A may be angled in a first twist direction, as shown for all of the propeller blades 114A in FIG. 1, and one or more extending blades 114B may be angled in the first twist direction, as shown for all of the extending blades 114B in FIG. 1. The twist direction(s) for a particular propeller 100 may be chosen and assigned as desired to various one(s) of the motive blades 114 (e.g., the propeller blades 114A and/or extending blades 114B) by one of ordinary skill in the art based on any desired factors, such as, but not limited to, achieving particular vortex properties during use of the propeller 100 and controlling tip speeds of the propeller blades 114A and/or extending blades 114B. It is generally contemplated that one or more motive blades 114, in any combination of types, may be angled in any other desired twist directions (not shown) and/or may have varying amounts/degrees of twist, as desired for a particular use environment of the propeller 100, and may be provided by one of ordinary skill in the art to achieve desired performance results. For example, a twist direction may have a first magnitude (e.g., amount of rotation from a zero-degree reference line) near a blade root 116, but change to a different magnitude, which may be larger or smaller than the first magnitude, approaching the blade tip 118 of that same motive blade 114.

The motive blades 114 of the propeller 100 may be arranged in any desired circumferential sequence(s) or grouping(s) about other portions of the propeller 100. For example, the plurality of propeller blades 114A shown in FIG. 1 are circumferentially spaced from one another about a perimeter 120 (shown in dotted line in FIG. 1) of the hub 102. The term “circumferentially” is used herein to indicate a circular direction which is centered on the longitudinal axis 104, such as the counterclockwise direction indicated by arrow C in the coordinate system of FIG. 1. Similarly, the plurality of extending blades 114B shown in FIG. 1 are circumferentially spaced from one another about the outer ring surface 110.

The arrangement of the various types of motive blades 114 about the circumference of the propeller 100 may assist with attenuating volume dependent thickness noise amplitude, particularly for small UAVs, over that which is currently available. A propeller 100, such as that depicted, is rotated in a first direction at a first rotational speed such as, for example, by motive power supplied by a drive shaft (not shown) extending along the longitudinal axis 104 and operatively connected to the hub 102. In other words, the hub 102, ring shroud 106, and motive blades 114 (including any propeller blade(s) 114A and extending blade(s) 114B provided to the propeller 100) are rotated in the first rotational direction at the first rotational speed. The propeller 100 should be configured such that the blade passage frequencies of the plurality of motive blades are aligned at respective harmonics to produce a predetermined passive noise cancellation effect, to substantially reduce audible detection range from an art-recognized value (e.g., a value currently achieved by commercially available small UAVs and/or toward a mission, immersed-background, and altitude-dependent parameter).

The arrangement of propeller blades 114A and extending blades 114B may be optionally, though not necessarily, done in a rotationally symmetrical manner. That is, the propeller 100 is “rotationally symmetrical” if it can be rotated less than 360° around the longitudinal axis 104 and still match its appearance before the rotation occurred. If the arrangement of propeller blades 114A and extending blades 114B is done in a rotationally asymmetrical manner, it may be desirable to balance the system for better temporal phase matching of thickness and loading noise sources, such as by locating lighter and/or smaller blades in areas of more concentrated spacing. It will often be desired, however, and is presumed in the below description, that adjacent propeller blades 114A will be at least somewhat circumferentially spaced from one another (i.e., separated by at least a few degrees and not overlapping), and that, likewise, adjacent extending blades 114B will be at least somewhat circumferentially spaced from one another (i.e., separated by at least a few degrees and not overlapping).

Whether or not the motive blades 114 are arranged rotationally symmetrically, the propeller 100 may be configured by one of ordinary skill in the art to achieve desired aerodynamic and/or acoustic results for a particular use environment. In a fairly straightforward arrangement (not shown), there may be equal numbers of propeller blades 114A and extending blades 114B, which are all circumferentially aligned such that each propeller blade 114A has a corresponding extending blade 114B located at substantially the same angular position about the hub 102. In another simple arrangement (also not shown), there are equal numbers of propeller blades 114A and extending blades 114B, which are all circumferentially spaced from one another in an “offset” fashion such that each propeller blade 114A is circumferentially separated from both the adjacent propeller blades 114A and from any circumferentially adjacent extending blades 114B.

As another, more complex arrangement, however, and as shown in FIG. 1, there may be differing numbers of propeller blades 114A and extending blades 114B collectively comprising the total motive blade 114 complement of the propeller 100. These propeller blades 114A and extending blades 114B are arranged, as shown, such that a portion of the plurality of extending blades 114B are circumferentially spaced from all of the plurality of propeller blades 114A, and a remaining portion of the plurality of extending blades 114B are each circumferentially aligned with a selected one of the plurality of propeller blades 114A.

More specifically, using the example configuration shown in FIG. 1, the nine extending blades 114B are evenly spaced, at 40° intervals, about the circumference of the ring shroud 106. The six propeller blades 114A are evenly spaced, at 60° intervals, about the circumference of the ring shroud 106. When the radial spacing of the extending blades 114B is the same as that of the propeller blades 114A, (e.g., at 0°, 120°, and the like), then those extending blades 114B (α, δ in FIG. 1) will be substantially circumferentially aligned with certain of the propeller blades 114A (Ω, φ in FIG. 1). Others of the extending blades 114B (β, γ in FIG. 1) will be substantially circumferentially spaced (or offset) from all of the propeller blades 114A Ω, ψ, φ in FIG. 1). Similarly, some of the propeller blades 114A (ψ in FIG. 1) may be substantially circumferentially spaced (or offset) from all of the extending blades 114B (α, β, γ, δ in FIG. 1).

Though the motive blades 114 in FIG. 1 are all shown as being evenly spaced (within their types), it is also contemplated that certain of the motive blades 114 could be unevenly spaced in comparison to others of the same type, as desired. One of ordinary skill in the art could determine a desired number, orientation, spacing, length(s), configuration, arrangement, or other physical properties of the motive blades 114 for a particular use environment.

The propeller 100 uses the ring shroud 106 for transferring forces across the propeller blades 114A which contribute to thickness and loading noise and set the pitch of the extending blades 114B to achieve a thrust balance striving toward a desired amount of passive cancellation of the pulse generated by the propeller blades 114A with the pulse emitted by the extending blades 114B. Important factors in seeking overall acoustic benefit are the thrust ratios between the plurality of propeller blades 114A and the plurality of extending blades 114B. For some use environments, it may be desirable to balance this thrust ratio for acoustic benefit. The balance could be even (50/50) or could be some other ratio, as desired for a particular use environment. Also, the placement of the propeller blades 114A and extending blades 114B may substantially affect acoustic results, and can be “tuned” by one of ordinary skill in the art for a desired use environment such that the extending blades 114B substantially compensate for (e.g., “cancel out”) radiated pulse from the propeller blades 114A. This propeller 100 also may use the ring shroud 106 supporting the motive blades 114 to enable greater loading distributions across the extending blades 114B, which can help contribute to acoustic source coherence reductions. The propeller 100 described herein utilizes passive noise cancellation to effectively produce incoherence between acoustic pressure pulses between motive blades 114. In many cases, high efficiency has positive correlation to low noise. It is contemplated that a propeller 100, such as that shown in FIG. 1, may remain a relevant technology in the event aeroacoustic performance is substantially enhanced at the expense of aerodynamic operating efficiencies.

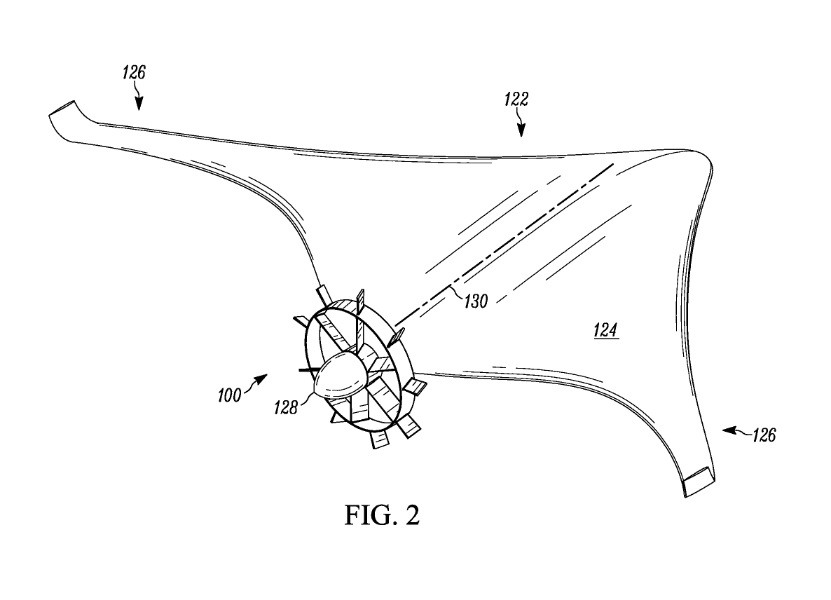

FIG. 2 depicts an example use environment for the propeller 100. An aircraft 122 is shown in FIG. 2 as a small UAV, but suitable use environments for the propeller 100 include, as nonlimiting examples, fixed-wing aircraft, helicopters or other rotor-driven aircraft, small UAVs, large UAVs, gas turbines, hydroelectric turbines, or any other desired use environments. Any number of propellers 100 can be provided to an aircraft 122, as desired, though a single propeller is shown in the Figures. The propeller(s) 100 could be in any suitable position or physical relationship to the other structures making up the aircraft 122. The aircraft 120 shown in FIG. 2 includes a body 124, at least one fixed wing 126 (two shown), and at least one propeller mount 128 (one shown) extending from the body 122. At least one drive shaft (somewhat concealed within the propeller mount 128, but indicated schematically at 130) is positioned within a corresponding at least one propeller mount 128 and is drivable by a motor or gear system (not shown, carried within the aircraft 122) to provide a source of rotationally oriented motive power. The propeller 100 is operationally attached to the drive shaft 130, optionally indirectly such as via a gearbox (not shown), to obtain motive power therefrom.

While aspects of this disclosure have been particularly shown and described with reference to the example embodiments above, it will be understood by those of ordinary skill in the art that various additional embodiments may be contemplated. For example, the specific methods described above for using the apparatus are merely illustrative; one of ordinary skill in the art could readily determine any number of tools, sequences of steps, or other means/options for placing the above-described apparatus, or components thereof, into positions substantively similar to those shown and described herein. In an effort to maintain clarity in the Figures, certain ones of duplicative components shown have not been specifically numbered, but one of ordinary skill in the art will realize, based upon the components that were numbered, the element numbers which should be associated with the unnumbered components; no differentiation between similar components is intended or implied solely by the presence or absence of an element number in the Figures. The propeller 100 could be used in any application or use environment wherein a fluid (e.g., liquid, gas, or any other material behaving in a fluid-like manner) interacts with a rotating structure (i.e., the propeller) to exchange (e.g., remove and/or provide) energy and/or motive power between the two. Any of the described structures and components could be integrally formed as a single unitary or monolithic piece or made up of separate sub-components, with either of these formations involving any suitable stock or bespoke components and/or any suitable material or combinations of materials. Any of the described structures and components could be disposable or reusable as desired for a particular use environment. Any component could be provided with a user-perceptible marking to indicate a material, configuration, at least one dimension, or the like pertaining to that component, the user-perceptible marking aiding a user in selecting one component from an array of similar components for a particular use environment. A “predetermined” status may be determined at any time before the structures being manipulated actually reach that status, the “predetermination” being made as late as immediately before the structure achieves the predetermined status. The term “substantially” is used herein to indicate a quality that is largely, but not necessarily wholly, that which is specified—a “substantial” quality admits of the potential for some relatively minor inclusion of a non-quality item. Though certain components described herein are shown as having specific geometric shapes, all structures of this disclosure may have any suitable shapes, sizes, configurations, relative relationships, cross-sectional areas, or any other physical characteristics as desirable for a particular application—e.g., certain of the extending blades 114B could be longer or shorter than others of the extending blades 114B. Any structures or features described with reference to one embodiment or configuration could be provided, singly or in combination with other structures or features, to any other embodiment or configuration, as it would be impractical to describe each of the embodiments and configurations discussed herein as having all of the options discussed with respect to all of the other embodiments and configurations. A device or method incorporating any of these features should be understood to fall under the scope of this disclosure as determined based upon the claims below and any equivalents thereof.

Other aspects, objects, and advantages can be obtained from a study of the drawings, the disclosure, and the appended claims.

What is claimed is:

1. A propeller, comprising:
a hub coaxially surrounding a longitudinal axis;
a ring shroud coaxially surrounding the longitudinal axis and spaced radially from the hub, the ring shroud including an inner ring surface and an oppositely facing outer ring surface;
at least one propeller blade fixedly attached to both the hub and the inner ring surface and extending radially therebetween for mutual rotation therewith; and
at least one extending blade having a first extending blade end radially spaced from a second extending blade end, the first extending blade end being fixedly attached to the outer ring surface, and the second extending blade end being cantilevered from the first extending blade end and radially spaced from the ring shroud.

2. The propeller of claim 1, including a plurality of propeller blades, the propeller blades being circumferentially spaced about a perimeter of the hub.

3. The propeller of claim 1, including a plurality of extending blades, the extending blades being circumferentially spaced about the outer ring surface.

4. The propeller of claim 1, wherein the propeller blades are angled in a first twist direction.

5. The propeller of claim 4, wherein the extending blades are angled in the first twist direction.

6. The propeller of claim 1, including a plurality of propeller blades and a plurality of extending blades, the propeller blades being circumferentially spaced about a perimeter of the hub and the extending blades being circumferentially spaced about the outer ring surface.

7. The propeller of claim 6, wherein a portion of the plurality of extending blades are circumferentially spaced from all of the plurality of propeller blades, and a remaining portion of the plurality of extending blades are each circumferentially aligned with a selected one of the plurality of propeller blades.

8. The propeller of claim 1, wherein a blade passage frequency of the at least one propeller blade is aligned with a blade passage frequency of the at least one extending blade at respective harmonics to produce a predetermined noise cancellation effect.

9. A propeller, comprising:
a hub coaxially surrounding a longitudinal axis;
a ring shroud coaxially surrounding the longitudinal axis and spaced radially from the hub, the ring shroud including an inner ring surface and an oppositely facing outer ring surface; and
a plurality of motive blades extending radially with respect to the longitudinal axis, each motive blade having a blade root directly attached to a chosen one of the hub and the outer ring surface, for rotation about the longitudinal axis due to the attachment to the chosen one of the hub and the outer ring surface, and a blade tip extending radially away from the longitudinal axis;
wherein at least one selected blade tip is directly attached to the inner ring surface; and
wherein at least one other blade tip is cantilevered from the outer ring surface and is radially spaced apart from the outer ring surface.

10. The propeller of claim 9, wherein all of the plurality of motive blades are angled in a first twist direction.

11. The propeller of claim 9, wherein the plurality of motive blades includes a plurality of propeller blades having blade roots directly attached to the hub and a plurality of extending blades having blade roots directly attached to the outer ring surface, the propeller blades being circumferentially spaced about a perimeter of the hub and the extending blades being circumferentially spaced about the outer ring surface.

12. The propeller of claim 11, wherein a portion of the plurality of extending blades are circumferentially spaced from all of the plurality of propeller blades, and a remaining portion of the plurality of extending blades are each circumferentially aligned with a selected one of the plurality of propeller blades.

13. The propeller of claim 9, wherein the blade passage frequencies of the plurality of motive blades are aligned at respective harmonics to produce a predetermined noise cancellation effect.

14. An aircraft comprising:
a body;
at least one fixed wing and at least one propeller mount extending from the body;
at least one drive shaft positioned within a corresponding at least one propeller mount and drivable by a motor or gear/clutch system; and
at least one propeller operationally attached to the at least one drive shaft to obtain motive power therefrom, the propeller comprising
a hub coaxially surrounding a longitudinal axis;
a ring shroud coaxially surrounding the longitudinal axis and spaced radially from the hub, the ring shroud including an inner ring surface and an oppositely facing outer ring surface; and
a plurality of motive blades extending radially with respect to the longitudinal axis, each motive blade having a blade root directly attached to a chosen one of the hub and the outer ring surface, for rotation about the longitudinal axis due to the attachment to the chosen one of the hub and the outer ring surface, and a blade tip extending radially away from the longitudinal axis;
wherein at least one selected blade tip is directly attached to the inner ring surface; and
wherein at least one other blade tip is cantilevered from the outer ring surface and is radially spaced apart from the outer ring surface.

15. The aircraft of claim 14, wherein all of the plurality of motive blades are angled in a first twist direction.

16. The aircraft of claim 14, wherein the plurality of motive blades includes a plurality of propeller blades having blade roots directly attached to the hub and a plurality of extending blades having blade roots directly attached to the outer ring surface, the propeller blades being circumferentially spaced about a perimeter of the hub and the extending blades being circumferentially spaced about the outer ring surface.

17. The aircraft of claim 14, wherein a portion of the plurality of extending blades are circumferentially spaced from all of the plurality of propeller blades, and a remaining portion of the plurality of extending blades are each circumferentially aligned with a selected one of the plurality of propeller blades.

18. The aircraft of claim 14, wherein the blade passage frequencies of the plurality of motive blades are aligned at respective harmonics to produce a predetermined noise cancellation effect.
